(19) United States
(12) Patent Application Publication
(10) Pub. No.: US 2012/0293912 A1
(43) Pub. Date: Nov. 22, 2012

(54) HYBRID CAPACITOR

(76) Inventors: Hak Kwan Kim, Seoul (KR); Dong Hyeok Choi, Gyeonggi-do (KR); Bae Kyun Kim, Gyeonggi-do (KR); Hyun Chul Jung, Gyeonggi-do (KR)

(21) Appl. No.: 13/445,793

(22) Filed: Apr. 12, 2012

(30) Foreign Application Priority Data
May 20, 2011 (KR) 10-2011-0047908

(51) Int. Cl. H01G 9/155

(52) U.S. Cl. 361/502

(57) ABSTRACT

Disclosed herein is a hybrid capacitor as a super capacitor including a positive electrode, a negative electrode, a separator, and an electrolyte solution, wherein the positive electrode includes a positive electrode active material including a material obtained by mixing a non-porous carbon material and a porous carbon material, and a positive electrode collector.

### CROSS REFERENCE(S) TO RELATED APPLICATIONS

This application claims the benefit under 35 U.S.C. Section 119 of Korean Patent Application Serial No. 10-2011-0047908, entitled “Hybrid Capacitor” filed on May 20, 2010, which is hereby incorporated by reference in its entirety into this application.

### BACKGROUND OF THE INVENTION

1. Technical Field

The present invention relates to a hybrid capacitor and, more particularly, to a hybrid capacitor which uses a material obtained by mixing a non-porous carbon material and a porous carbon material as a positive electrode active material and lithium titanate oxide (LTO) as a negative electrode material to thereby enhance energy density, improve output characteristics, and secure stability.

2. Description of the Related Art

A secondary battery such as a lithium ion battery, or the like, is a typical energy storage device having high energy density which has recently come to prominence and is utilized as an important energy storage device for various mobile electronic devices.

Meanwhile, a device called an ultra-capacitor or a super-capacitor, among next-generation energy storage devices, has been spotlighted as a next-generation energy device due to its fast charging and discharging speed, high stability, and environmentally friendly characteristics.

Here, as for types of super-capacitors, a general super-capacitor includes an electrode structure, a separator, an electrolyte solution, and the like. The super-capacitor is driven based on a principle of an electrochemical reaction mechanism in which carrier ions in the electrolyte solution are selectively adsorbed to electrodes by applying power to the electrode structure. Currently, typical super-capacitors include a lithium ion capacitor (LIC), an electric double layer capacitor (EDLC), a pseudo-capacitor, a hybrid capacitor, and the like.

The lithium ion capacitor is a super capacitor which uses a positive electrode made of activated carbon, a negative electrode made of graphite, and lithium ions as carrier ions. The EDLC is a super capacitor which uses an electrode made of activated carbon and electric double layer charging as a reaction mechanism. The EDLC, the most commonly used super capacitor currently, exhibits excellent stability of an electrode material itself and is made of an environmentally friendly carbon material. Such a carbon electrode material may include activated carbon, carbon nano-tube (CNT), activated carbon nano-fiber (ACNF), graphene, and the like, to which carbon black, Ketjen black, CNT, graphene, or the like, having a relatively excellent electrical conductivity is added as a conductive material.

The pseudocapacitor is a super capacitor which uses a transition metal oxide or a conductive polymer as an electrode and pseudo-capacitance as a reaction mechanism. The hybrid capacitor is a super capacitor having intermediate characteristics between the EDLC and the pseudocapacitor.

However, such energy storage devices have a relatively low capacity compared with a secondary battery. This is because the most of the foregoing super capacitors are driven according to a charging/discharging mechanism using the carrier ion movement between interfaces of an electrolyte solution and electrodes and a chemical reaction on an electrode surface. Thus, currently, development of a technique for enhancing relatively low capacity is required for the energy storage devices such as the super capacitors.

Referring to FIG. 1, the super capacitor includes metal material current collectors 10 and 20, electrodes, an electrolyte solution 13, and a separator 14. The electrolyte solution 13 is filled between two electrodes electrically separated by the separator 14, and the metal material current collectors 10 and 20 serve to effectively charge or discharge electric charges to and from the electrodes.

In case of the EDLC, the electrodes are made of activated carbon, and the activated carbon is porous, namely, it includes fine pores, to have a wide specific surface area. Thus, when a negative (−) voltage is applied to the activated carbon electrode, positive (+) ions dissociated from electrolyte come into the pores of the activated carbon electrode to form a positive (+) layer, resulting in a formation of an electric double layer with the positive (+) layer formed on the interface of the activated carbon electrode to charge electric charges. Here, the capacity of the super capacitor relies on the structure and physical properties of the electrodes. Namely, the capacity of the super capacitor is increased as the specific surface area is larger, internal resistance and contact resistance are smaller, and the density of the carbon material is higher. In this case, when the density of the electrode active material is low, generally, resistance is increased and capacitance is reduced. Thus, the density, resistance, and capacitance of the electrode fabricated by using an active material and a conductive material are closely related.

In general, since the super capacitor mainly uses electrostatic properties as shown in FIG. 1, it can be charged and discharged by a remarkably larger number of times than the battery using an electrochemical reaction. Thus, the super capacitor can be used semi-permanently, and since the charging and discharging speed of the super capacitor is very fast, an output density is also superior by more than tens of times to that of the secondary battery.

Thus, due to the advantages of the super capacitor which cannot be easily implemented by the existing secondary battery, the application field of the super capacitor has been gradually increasing.

In particular, the usefulness of the super capacitor is growing in a next-generation environmentally-friendly automobile field such as an electric vehicle, a fuel-cell vehicle, or the like. The super capacitor is connected, as an auxiliary energy storage device, with a secondary battery so as to be used. The super capacitor may be responsible for an instant supply of energy and the secondary battery may serve to supply normal vehicle energy, thereby improving the efficiency of a general vehicle system and lengthening the life span of the energy storage system. Also, the super capacitor may be used as an auxiliary power source in heavy equipment such as an excavator, in an energy storage device in the field of UPS, wind power generation, or solar power generation, and mobile electronic components such as a mobile phone, a video player, or the like.

Meanwhile, the secondary battery advantageously has a high energy density but it is disadvantageous in that output characteristics are limited. The output characteristics of the super capacitor are highly superior to that of the secondary battery, but energy density of the super capacitor is lower.

In case of a lithium ion capacitor (LIC), a sort of hybrid capacitor, which has come to prominence recently, activated carbon is used for a positive electrode and a carbon material, largely, graphite, capable of occluding and eliminating lithium ions, is used for a negative electrode. The LIC can have a higher voltage and higher energy density as compared with the related art EDLC, and can have a high output and excellent cycle characteristics as compared with the related art lithium ion battery. However, since the activated carbon is used for the positive electrode, the LIC is limited by the performance of the positive electrode although it has an energy density higher than that of the EDLC. Also, since a carbon material for occluding and eliminating lithium ions is used for the negative electrode and the potential of the negative electrode is near a potential at which lithium is precipitated, and as a result; an internal short-circuit occurs due to the precipitation of lithium, failing to guarantee stability of a repeated cycle.

Thus, the necessity of a technique for basically solving the problems is increasing.

### SUMMARY OF THE INVENTION

An object of the present invention is to provide a hybrid capacitor including a positive electrode made of a mixture of a non-porous carbon material and a porous carbon material, thus improving outputs and capacity.

Another object of the present invention is to provide a hybrid capacitor including a negative electrode made of non-carbon material such as lithium titanate oxide, or the like, which can occlude and eliminate lithium ions, thus improving stability and reliability.

Another object of the present invention is to provide a hybrid capacitor having a negative electrode with a novel structure to thus solve a short-circuit problem caused by a dendrite growth of lithium and having a positive electrode structure using a mixed positive electrode material to thus solve a problem of a reduction in capacity and energy density due to a reduction in an operation voltage.

According to an exemplary embodiment of the present invention, there is provided a hybrid capacitor as a super capacitor including a positive electrode, a negative electrode, a separator, and an electrolyte solution, wherein the positive electrode includes a positive electrode active material including a material obtained by mixing a non-porous carbon material and a porous carbon material, and a positive electrode collector.

According to an exemplary embodiment of the present invention, there is provided a hybrid capacitor as a super capacitor including a positive electrode, a negative electrode, a separator, and an electrolyte solution, wherein the negative electrode includes a negative electrode active material formed of a non-carbon material having a relative potential of 1.0V or higher compared with lithium ions, and a negative electrode collector.

According to an exemplary embodiment of the present invention, there is provided a hybrid capacitor as a super capacitor including a positive electrode, a negative electrode, a separator, and an electrolyte solution, wherein the positive electrode includes a positive electrode active material including a material obtained by mixing a non-porous carbon material and a porous carbon material, and a positive electrode collector, and the negative electrode includes a negative electrode active material formed of a non-carbon material having a relative potential of 1.0V or higher compared with lithium ions, and a negative electrode collector.

The non-porous carbon material may have a structure in which lithium ions can be occluded and eliminated.

The content of the non-porous carbon material of the positive electrode active material may range from 20 wt % to 80 wt %.

The non-carbon material may have a volume variation of 5% or lower.

The non-carbon material may be lithium titanate oxide (Li₄Ti₅O₁₂).

A specific surface area of the non-porous carbon material may be 50 m/g or lower, and a specific surface area of the porous carbon material may be 1500 m²/g or higher.

### BRIEF DESCRIPTION OF THE DRAWINGS

FIG. 1 is a view showing the structure of a general super capacitor according to the related art.

FIG. 2 is a cross-sectional view showing the configuration of a hybrid capacitor according to an exemplary embodiment of the present invention.

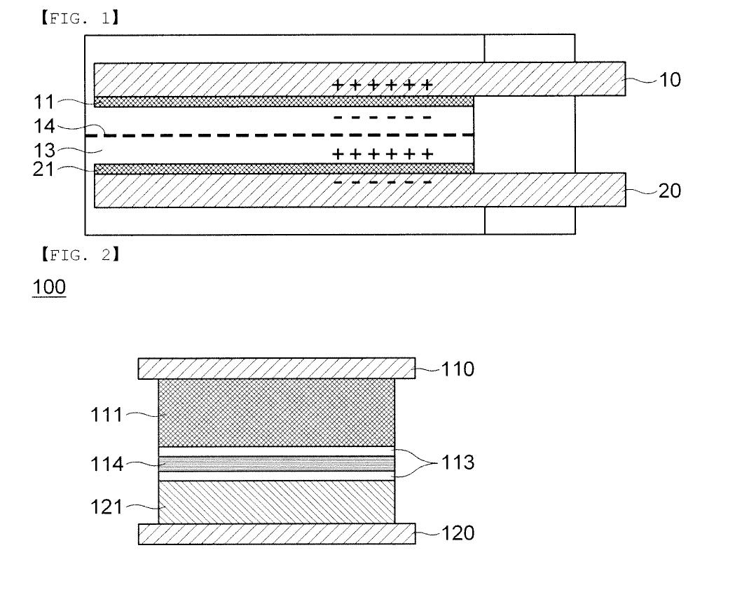

### DESCRIPTION OF THE PREFERRED EMBODIMENTS

The foregoing and other objects, features, aspects and advantages of the present invention will become more apparent from the following detailed description of the present invention when taken in conjunction with the accompanying drawings. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. Like numbers refer to like elements throughout the specification.

The terms used in the present application are merely used to describe particular embodiments, and are not intended to limit the present invention. As used herein, the singular forms “a”, “an”, and “the” are intended to include the plural forms as well, unless the context clearly indicates otherwise. It will be further understood that the terms “comprises”, “comprising”, “includes” and/or “including” when used herein, specify the presence of stated features, integers, steps, operations, elements, and/or components, but do not preclude the presence or addition of one or more other features, steps, operations, elements, components, and/or groups thereof.

An energy storage device according to an exemplary embodiment of the present invention will be described in detail with reference to the accompanying drawings.

FIG. 2 is a cross-sectional view showing the configuration of a hybrid capacitor according to an exemplary embodiment of the present invention.

Referring to FIG. 2, a hybrid capacitor 100 according to an exemplary embodiment of the present invention may be configured to include a positive electrode including a positive electrode collector 110 and a positive electrode active material 111, a negative electrode including a negative electrode collector 120 and a negative electrode active material 121, a separator 114, and an electrolyte solution 113.

The positive electrode active material is configured to include the positive electrode collector 110 and the positive electrode active material 111 including a material obtained by mixing a non-porous carbon material and a porous carbon material. In comparison, the related art super capacitor largely uses the porous activated carbon as the positive electrode active material 111.

Namely, the related art lithium ion capacitor using only the amorphous activated carbon without a crystal structure as the positive electrode active material 111 has a limitation in capacity, but in the exemplary embodiment of the present invention, a non-porous carbon material theoretically having a capacity 10 times or greater than that of the amorphous activated carbon is mixed to improve the capacity of the capacitor.

In this case, the non-porous carbon material refers to a carbon material having a specific surface area of 50 m²/g or smaller, and graphite, or the like, may correspond to the non-porous carbon material.

Also, the porous carbon material refers to a carbon material having a specific surface area of 1500 m²/g or larger, and activated carbon, or the like, may correspond to the porous carbon material.

Only the surface area of the porous carbon material is reflected in capacity, while the overall bulk or volume of the non-porous carbon material can be reflected in capacity. Thus, energy density can be enhanced by employing the non-porous carbon material.

In detail, by using the material obtained by mixing the non-porous carbon material and the porous carbon material, the same capacity can be implemented with a smaller amount of carbon material, compared with a case in which a particular capacity is implemented only with amorphous activated carbon or a porous carbon material, such that the positive electrode active material layer 111 can become thinner.

Also, since the positive electrode active material layer 111 can become thinner, resistance can be reduced.

In this case, if the content of the non-porous carbon material in the positive electrode active material 111 is too large, the capacity of the capacitor can be increased but output characteristics can be reduced.

Also, if the content of the non-porous carbon material in the positive electrode active material 111 is too small, the effect of improving the capacity of the capacitor can be drastically reduced.

Thus, it is important to find optimum conditions of the content of the non-porous carbon material.

Experiments were conducted with various conditions tens of thousands of times, and the results showed that when the content of non-porous carbon material is within a range from 20 wt % to 80 wt % of the overall weight of the positive electrode active material, the reduction in the output characteristics is minimized and the increase in capacity is maximized.

Meanwhile, the non-porous carbon material may have a structure in which lithium ions are occluded or eliminated. In this case, the structure in which lithium ions are occluded or eliminated may be similar to a two-dimensional plate type structure of a metal oxide containing lithium ions such as lithium cobalt oxide (LiCoO₂) commonly used in a lithium ion secondary battery and the applied principle is also similar, so a detailed description thereof will be omitted.

In the hybrid capacitor 100 according to an exemplary embodiment of the present invention, which is configured as a super capacitor including a positive electrode, a negative electrode, the separator 114, and the electrolyte solution 113, the negative electrode may include the negative electrode active material 121 formed of a non-carbon material having a relative potential of 1.0 V or higher compared with lithium ions and the negative electrode collector 120.

In general, graphite, or the like, is commonly used as a negative electrode material of the hybrid capacitor, and in this case, a lithium pre-doping process at about 0.1 V is performed in order to increase the capacity.

However, when the relative potential versus lithium ions is smaller than 1.0V, so-called dendrite may grow as lithium ions are precipitated from the negative electrode and accumulated according to the repeated operation of the charging and discharging mechanism.

When the dendrite formation continues, a short-circuit occurs as different electrodes come into contact, preventing the capacitor from operating normally.

Thus, in order to solve such a problem, in the hybrid capacitor according to an exemplary embodiment of the present invention, the negative electrode active material 121 is made of a non-carbon material having a relative potential of 1.0 V or higher compared with the lithium ions.

Meanwhile, when a volume variation of the non-carbon material used as the negative electrode active material 121 is large, a short-circuit phenomenon as in the related art hybrid capacitor may possibly occur, so preferably, the non-carbon material having a volume variation of 5% or smaller is used.

As a material having a relative potential of 1.0 V or higher compared with lithium ions and a low volume variation, lithium titanate oxide (Li₄Ti₅O₁₂) may be considered. Since lithium titanate oxide has a relative potential of about 1.5 V compared with lithium ions, when the negative electrode active material 121 implemented with lithium titanate oxide, a short-circuit phenomenon caused by the precipitation of lithium ions can be basically prevented.

Meanwhile, the formation of negative electrode active material 121 with a material having a relative potential of 1.0V or higher compared with lithium ions may accompany a reduction in capacity according to a reduction in the overall operation voltage of the capacitor, even though the short-circuit phenomenon in the negative electrode is solved.

In this case, since the positive electrode active material 111 in the hybrid capacitor according to an exemplary embodiment of the present invention is implemented by a material obtained by mixing a non-porous carbon material and a porous carbon material, the reduced capacity can be offset.

According to the exemplary embodiments of the present invention, since the positive electrode of the hybrid capacitor is made of a material obtained by mixing a non-porous carbon material and a porous carbon material, the energy density and output characteristics can be enhanced.

Also, since the negative electrode of the hybrid capacitor is made of a non-carbon material, charging and discharging operation can be performed at a potential higher than a potential at which lithium can be precipitated, the problem of the related art LIC in which a short-circuit occurs due to the precipitation of lithium to reduce stability and reliability can be solved.

In addition, since the negative electrode of the hybrid capacitor is made of a material operating at a potential higher than the potential at which lithium can be precipitated, the stability can be improved, and since the energy density and output characteristics are improved by using the mixed positive electrode material, the reduction in the capacity and energy density according to a reduction in the operation voltage due to a high potential of a negative electrode can be compensated for. Thus, compared with the related art LIC, the hybrid capacitor according to an exemplary embodiment of the present invention can have a capacity which is similar or greater and improved stability.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A hybrid capacitor as a super capacitor including a positive electrode, a negative electrode, a separator, and an electrolyte solution,
wherein the positive electrode includes a positive electrode active material including a material obtained by mixing a non-porous carbon material and a porous carbon material, and a positive electrode collector.

2. A hybrid capacitor as a super capacitor including a positive electrode, a negative electrode, a separator, and an electrolyte solution,
wherein the negative electrode includes a negative electrode active material formed of a non-carbon material having a relative potential of 1.0V or higher compared with lithium ions, and a negative electrode collector.

3. A hybrid capacitor as a super capacitor including a positive electrode, a negative electrode, a separator, and an electrolyte solution,
wherein the positive electrode includes a positive electrode active material including a material obtained by mixing a non-porous carbon material and a porous carbon material, and a positive electrode collector, and the negative electrode includes a negative electrode active material formed of a non-carbon material having a relative potential of 1.0V or higher compared with lithium ions, and a negative electrode collector.

4. The hybrid capacitor according to claim 3, wherein the non-porous carbon material has a structure in which lithium ions can be occluded and eliminated.

5. The hybrid capacitor according to claim 3, wherein the content of the non-porous carbon material of the positive electrode active material ranges from 20 wt % to 80 wt %.

6. The hybrid capacitor according to claim 3, wherein the non-carbon material has a volume variation of 5% or lower.

7. The hybrid capacitor according to claim 3, wherein the non-carbon material is lithium titanate oxide (Li₄Ti₅O₁₂).

8. The hybrid capacitor according to claim 3, wherein a specific surface area of the non-porous carbon material is 50 m/g or lower.

9. The hybrid capacitor according to claim 3, wherein a specific surface area of the porous carbon material is 1500 m²/g or higher.

10. The hybrid capacitor according to claim 3, wherein a specific surface area of the non-porous carbon material is 50 m²/g or lower, and a specific surface area of the porous carbon material is 1500 m/g or higher.
